(19) United States
(12) Patent Application Publication
(10) Pub. No.: US 2008/0182487 A1
(43) Pub. Date: Jul. 31, 2008

(54) COOLING DISC, GRINDING SYSTEM AND GRINDING TOOL

(75) Inventors: Patrick Müller, Hüttwilen (CH); Josef Breitenmoser, Eschikofen (CH)

Correspondence Address: SHOEMAKER AND MATTARE, LTD, 10 POST OFFICE ROAD - SUITE 110, SILVER SPRING, MD, 20910, US

(73) Assignee: sia Abrasives Industries AG, Frauenfeld (CH)

(21) Appl. No.: 11/959,657

(22) Filed: Dec. 19, 2007

(30) Foreign Application Priority Data
Dec. 19, 2006 (EP) 06126474.3

(51) Int. Cl. B24B 1/00; B23F 21/02

(52) U.S. Cl. 451/53; 451/548; 451/540

(57) ABSTRACT

The present invention relates to a cooling disc for cooling grinding tools, having at least one fastening opening, a side which can face a grinding tool, a side which can face away from a grinding tool, a first contact face which is configured in such a way that it can be brought into contact with a corresponding face of a holding element of a grinding tool, and a second contact face which is configured in such a way that it can be brought into contact with a corresponding face of a fixture for a grinding tool. Furthermore, the invention relates to a grinding system which comprises at least one grinding tool which is provided with a holding element, a fixture for a grinding tool, and at least one cooling disc. A further subject matter of the invention is a grinding tool having a carrying body and an abrasive which is fastened to the carrying body, by means of which the carrying body can be fastened in a fixture for a grinding tool, the grinding face being substantially planar and closed and the carrying body comprising vulcanized fiber.

The invention relates to a cooling disc for cooling grinding tools, to a grinding system and to a grinding tool having the features of the preambles of the independent patent claims.

During work with rotating and, in particular, machine-driven grinding tools, considerable heating occurs at the contact face between the grinding face and the processed material on account of the often high rotational speeds and the exerted contact pressure. This proves disadvantageous, since both the grinding face itself, the carrier of the grinding face and the processed material can be damaged as a result.

A plurality of grinding tools have already been proposed which are intended to remedy this problem and, in particular, to cool the grinding tool. Firstly, cooling is achieved by feeding in a cooling medium in DE 103 61 895 A1, DE 197 38 394 A1 or WO 2005/023490 A1. However, this requires complicated apparatuses which are intensive to maintain for supplying this cooling medium, and is therefore frequently complicated in practice.

Secondly, it has been proposed to supply the surrounding air to the grinding tool by means of air holes and/or channels, in order to achieve cooling. Here, the grinding face is perforated, such as in DE 2 145 714 A; the grinding face is penetrated by channels, such as in DE 197 04 746 A1; or the entire grinding body is penetrated by channels as in FR 2 704 473 A3. All these grinding tools have the disadvantage that their production is more complicated, the useable grinding face is reduced and the openings in the grinding face can be clogged by the removed material. Moreover, it can be appropriate to cool only in certain working steps or to cool in a series of working steps with in each case different degrees of efficacy. A function of this type is precluded in principle in the grinding tools which are cited above.

EP 874 717 B1 discloses a circular carrier plate for grinding discs, the carrier plate containing both a fastening opening and cut-outs, through which the user can see the surface which is to be ground. Moreover, the plate can be provided with channels on the bearing face for grinding discs, which channels are designed for circulating air in the space between the carrier plate and the grinding disc. However, this carrier plate has the disadvantage that it can be mounted on the drive only with great effort, since a separate, non-captive nut is required for this purpose.

The use of grinding tools, the carrying body of which comprises vulcanized fiber, has proven particularly favorable for certain applications, for instance when removing large surface areas of steel, Inox or other non-ferrous metals by grinding. In order to keep the temperature low at the grinding face for as long as possible during a continuous grinding operation, the layer thickness of this material is selected to be as high as possible, in order that it has a sufficient thermal capacity. Usual thicknesses lie in the range from 0.65 mm to 0.84 mm. However, the requirement for thicknesses of this type is associated with very high material costs.

Finally, it is necessary in conventional vulcanized-fiber grinding discs for use in the cooled grinding of hard surfaces to fasten the disc to the drive by way of a securing nut or similar means, as disclosed, for instance, in DE 44 30 229 A1. This requires a central through hole of the grinding disc, which likewise leads to a disadvantageous reduction in the usable grinding surface area and higher production costs.

It is therefore the object of the present invention to eliminate the disadvantages of the known means. In particular, an apparatus for cooling a grinding tool is to be provided, which apparatus can be used universally and avoids openings, channels or the like in the usable grinding face of the grinding tool.

According to the invention, these objects are achieved with a cooling disc for cooling grinding tools, a grinding system and a grinding tool having the features of the characterizing parts of the independent patent claims.

The cooling disc according to the invention for cooling grinding tools has at least one fastening opening and a side which can face the grinding tool and a side which can face away from the grinding tool. Furthermore, the cooling disc according to the invention has a first contact face which is configured in such a way that it can be brought into contact with a corresponding face of the holding element of the grinding tool, and a second contact face which is configured in such a way that it can be brought into contact with a corresponding face of a fixture for a grinding tool.

The abovementioned features make it possible to clamp the cooling disc between the fixture and the holding element of a grinding tool. Here, the cooling disc can be used optionally, since the fixture can also be connected directly to the grinding tool. Furthermore, it is conceivable to provide a set of different cooling discs which are to be used depending on requirements. Moreover, it is conceivable to use one and the same cooling disc for a large number of different grinding tools which each have identical holding elements.

Here, as in the following text, grinding tools denote all tools which are provided with a grinding face, which are rotatable, in particular, and can be driven, in particular, by a machine. In particular, they can be grinding discs. Here, grinding discs are preferred, the grinding face of which is situated on a flat side of the grinding disc. A grinding disc of this type is configured in such a way that they are suitable for machining surfaces, in particular for removing material and/or for polishing.

The fastening opening penetrates the cooling disc from the side which can face the grinding tool to the side which can face away from the grinding tool. As a result of this fastening opening, the cooling disc can be connected together with a grinding tool to a rotating drive.

The carrying body of the grinding tool can be fastened in a fixture for a grinding tool by way of the holding element.

It is particularly favorable if the cooling disc can be connected simultaneously to the holding element of a grinding tool by means of the first contact face and to the fixture for a grinding tool by means of the second contact face.

In one preferred embodiment, the cooling disc according to the invention has at least one ventilation opening which penetrates the cooling disc. This at least one ventilation opening preferably extends from the side which can face away from the grinding tool to the side which can face the grinding tool.

During rotation of the cooling disc about its rotational axis, this at least one ventilation opening can serve to convey the medium which surrounds the cooling disc from the side which faces away from the grinding tool to the side which faces the grinding tool and therefore to bring about cooling of the grinding tool. For this purpose, the at least one ventilation opening can be wound around the rotational axis in the form of a helical line. In particular, the cooling disc can have a plurality of ventilation openings, at least two of the ventilation openings being separated from one another by a dividing face which has a shape similar to a turbine-wheel blade. The dividing faces are preferably delimited in the radial direction by two concentric cylindrical rings.

In a further preferred embodiment, the cooling disc can be provided with at least one channel on the side which can face the grinding tool, which at least one channel is designed for circulating air in the space between the cooling disc and the grinding tool. This air circulation is caused by rotation of the grinding tool, which results in cooling of the grinding tool.

In a further preferred embodiment, at least one of the channels can open into an opening on the outer circumference of the cooling disc. Moreover, if at least one ventilation opening on the side which can face the grinding tool is connected to one of the channels, the surrounding air can be guided through the at least one ventilation opening to the side which can face the grinding tool and, from there, through the channel to the outer circumference of the cooling disc during rotation of the cooling disc. In this way, air can be fed to the grinding tool, which air can absorb the heat which is produced there and can dissipate it at the outer edge to the surroundings, which can lead to effective cooling of the grinding tool.

According to a further preferred embodiment, at least one part of the first contact face can be formed at least partially by a face which delimits one of the fastening openings. In particular, the first contact face can coincide with the entirety of all faces which delimit the fastening openings. Here, in particular, the face can also mean a thin edge or a collar which delimits the fastening opening.

The use of the face which delimits the fastening opening as first contact face leads to a particularly simple embodiment of the cooling disc and additionally guarantees an inherent accurate fit during assembly.

In a further preferred embodiment, the second contact face is directed to the outside. That is to say, the external normal of the face is directed at an acute angle or parallel to the centrifugal forces which act during rotation of the cooling disc about its rotational axis. In particular, a face of this type can also comprise a thin edge or a collar which points in one of the denoted directions.

During the use of the cooling disc with a grinding tool and a fixture, the contact of that face of the cooling disc which is directed to the outside with the corresponding face of the fixture causes the centrifugal forces which occur during rotation to be transmitted effectively to the fixture.

According to a further preferred embodiment, one of the two contact faces is configured substantially as a cone envelope and the other contact face is configured substantially as a cylinder or cone envelope, in such a way that both contact faces converge to form an edge on that side which can face away from the grinding tool. This brings about a particularly simple structural shape. In a particularly preferable manner, the first contact face is of cylindrical configuration and the second contact face is of conical configuration. The angle between these contact faces lies in the range between 20° and 45°, and preferably at approximately 30°.

The contact faces are preferably arranged in such a manner that the ventilation openings are situated outside of the radius which is defined by the outermost circumference of the contact faces. The contact faces are particularly preferably arranged within the inner of the two concentric cylindrical rings which delimit the dividing faces in the radial direction. The two contact faces therefore form the outer face of a collar which, on the side which can face the grinding tool, is connected to the inner of the two concentric cylindrical rings which delimit the dividing faces in the radial direction.

The edge, at which the two contact faces converge, preferably lies at a spacing from the side which can face the grinding tool, which spacing corresponds to only a fraction of the overall thickness of the cooling disc. This fraction preferably lies in the range between 20% and 80%, particularly preferably between 50% and 70%. In particular, the entire collar and the edge lie between the two planes which are defined firstly by the side which can face the grinding tool and secondly by that end of the inner cylindrical ring which can face away from the grinding tool.

Furthermore, the invention relates to a grinding system which comprises
at least one grinding tool which is provided with a holding element,
a fixture for a grinding tool, and
at least one cooling disc,
it being possible for at least one of the grinding tools to be connected releasably by means of its holding element to the fixture in such a way that one of the cooling discs can be connected releasably to the fixture and the holding element.

The system preferably comprises at least one cooling disc according to the above description. The shape and the size of the cooling disc are preferably adapted to the shapes and sizes of the grinding tools. In particular, in the case of grinding discs having a circular outer circumference, the outer circumference of the cooling disc is preferably likewise circular. In this case, the cooling disc preferably has approximately the same external radius as the grinding disc.

A fixture for a grinding tool means every suitable means, by means of which the grinding tool can be connected releasably to a rotating drive, in particular to a rotating machine drive. The fixture is preferably configured as one component. The fixture particularly preferably comprises a plurality of individual parts which can move relative to one another, in particular at least two individual parts which can rotate relative to one another. The fixture is particularly preferably configured in such a way that its individual parts do not have to be separated from one another during the connection to the holding element of the grinding tool. The risk that one of the components can be lost during the mounting is therefore eliminated.

It can be particularly advantageous if the grinding system has at least two cooling discs, at least two of the cooling discs being different from one another. These different cooling discs can differ, in particular, as a result of their shapes, sizes and cooling properties and can be adapted to the respective requirements during grinding.

According to one preferred embodiment of the grinding system, at least one of the grinding tools can be connected releasably by means of its holding element directly to the fixture, even without a cooling disc. It is particularly preferred here if the constituent parts of the system are configured in such a way that, for the releasable connection of the holding element of the grinding tool to the fixture, the same relative movements of the components of the fixture which can move relative to one another and the same relative movements between the holding element and the fixture are carried out, irrespective of whether the cooling disc is connected to the holding element and the fixture or not.

This results in the possibility of using the cooling disc optionally and only when required. Furthermore, it is possible to select a suitable cooling disc from a set of different cooling discs in accordance with the respective requirements.

In a further preferred embodiment of the grinding system, the contact faces of at least one of the cooling discs are configured in such a way that the first contact face is adapted to a corresponding face of a holding element of the grinding tool, and the second contact face is adapted to a corresponding face of the fixture for a grinding tool.

In one particularly preferred embodiment, the releasable connection of the cooling disc to the holding element and the fixture is effected by means of the clamping of the cooling disc between the respective corresponding faces on the holding element and the fixture.

Here, the contact of the outwardly directed face of the cooling disc with the corresponding face of the fixture causes the centrifugal forces which act during rotation to be transmitted effectively to the fixture. The cooling disc is therefore clamped and supported in the radial direction.

In one preferred embodiment, the holding element of at least one grinding tool comprises a ring having a flange which extends radially to the outside, a plurality of cams, in particular four, which are arranged uniformly over the circumference of the ring extending radially to the inside from the inner side of the ring. At least one contact face of a cam comes into contact with a bearing face of the fixture during connection of the holding element to the fixture during connection of the holding element to the fixture with simultaneous clamping of the cooling disc. Here, the outer side of the ring forms the corresponding face on the holding element.

The cams can be configured in such a way that, during connection of the holding element to the fixture, they ensure the transmission of force between the holding element and the fixture. The geometry of the cams and the fixture are preferably adapted to one another in such a way that the holding element can be held on the fixture by the contact of the cam with the fixture.

The configuration of the outer side of the ring as corresponding face on the holding element leads to a form-fitting and force-transmitting, radial connection of the cooling disc to the holding element. In particular, during rotation of the system, the radial forces can therefore be transmitted advantageously.

Furthermore, the invention relates to a grinding tool, in particular in a grinding system according to the invention, having a carrying body and a grinding face which is fastened to the carrying body and by means of which the carrying body can be fastened in a fixture for a grinding tool, the grinding face being substantially planar and closed and the carrying body comprising vulcanized fiber.

The fixture can once again be every suitable apparatus, by means of which the grinding tool can be connected to the drive.

Here, the grinding face can have any shape which is suitable for grinding and can comprise any suitable grinding material. It goes without saying here that complete flatness of the grinding face is not achieved or cannot be achieved on account of the protruding grinding material, for instance the protruding grinding grains.

The closed nature of the grinding face precludes, in particular, holes, notches and the like. In particular, the grinding face does not have a central opening, by means of which it would be connected to a drive. This results in the advantage that the size of the usable grinding face is increased. Clogging which impedes the grinding process can occur in the case of grinding tools having holes, notches and the like in the grinding face. This disadvantage is also eliminated in the grinding tool according to the invention.

A further aspect of the invention relates to a grinding tool, the carrying body of which, made from vulcanized fiber, has a thickness of the most 0.4 mm. The carrying body particularly preferably has a thickness in the range from 0.35 mm to 0.38 mm. A layer thickness of this type has the consequence of lower material costs. Although a layer which is this thin has only a small thermal capacity and can therefore be heated more rapidly during continuous grinding without further precautions, this is not a problem if a cooling disc according to the invention is used, since the heat can be dissipated as a result of this.

One particularly preferred embodiment of the grinding system comprises at least one grinding tool having a carrying body and a holding element which is fastened to the carrying body and by means of which the carrying body can be fastened in a fixture for a grinding tool, the grinding disc being substantially planar and closed and the carrying body comprising vulcanized fiber. Therefore, if the cooling disc is used in combination with the said grinding tool, the cooling disc can assume an additional supportive function for the grinding tool and therefore also ensure sufficient stability in the case of relatively thin vulcanized-fiber layers.

In the following text, the invention will be explained in greater detail in exemplary embodiments and using the drawings, in which:

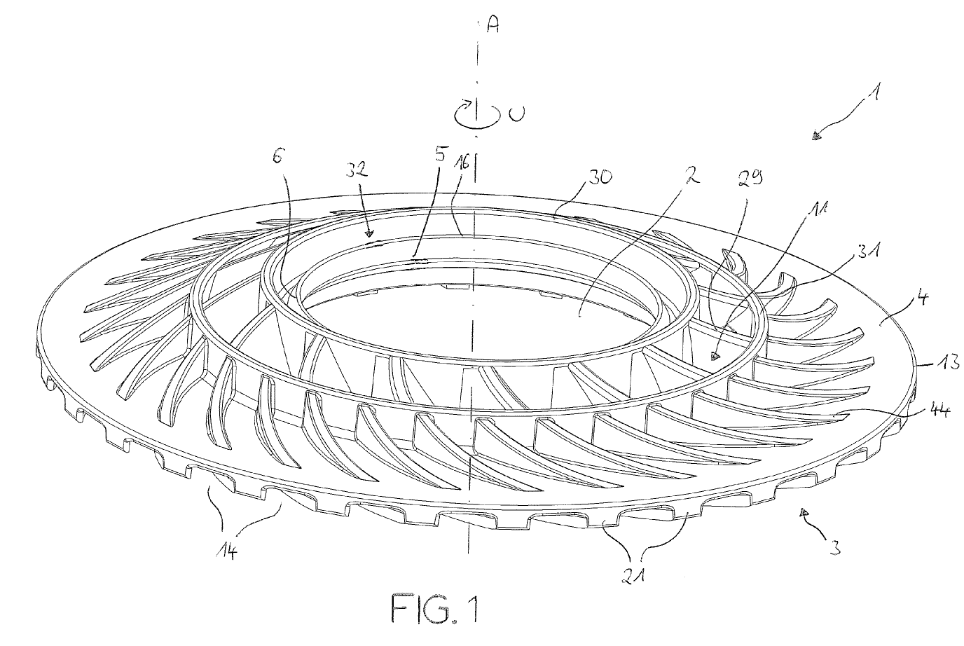

FIG. 1 shows a perspective view of a cooling disc according to the invention (obliquely from above),

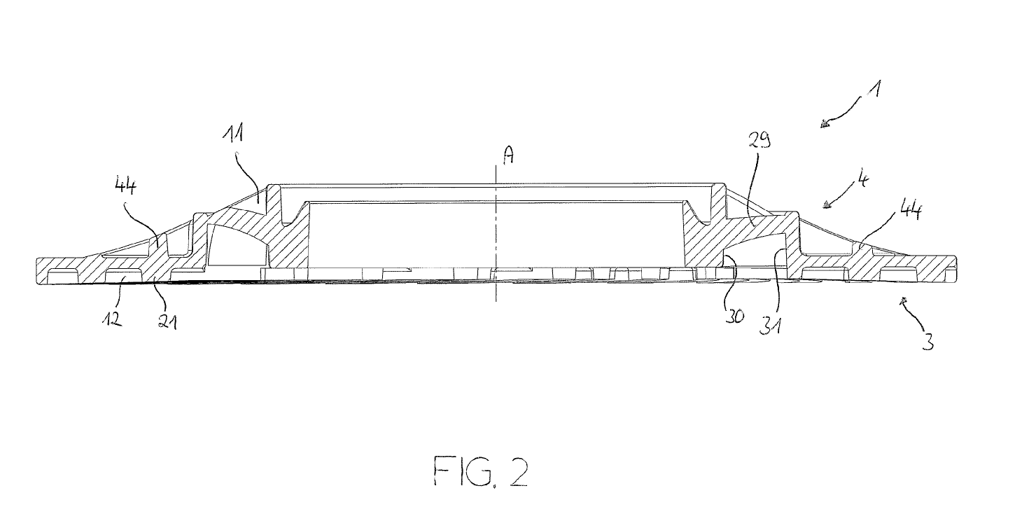

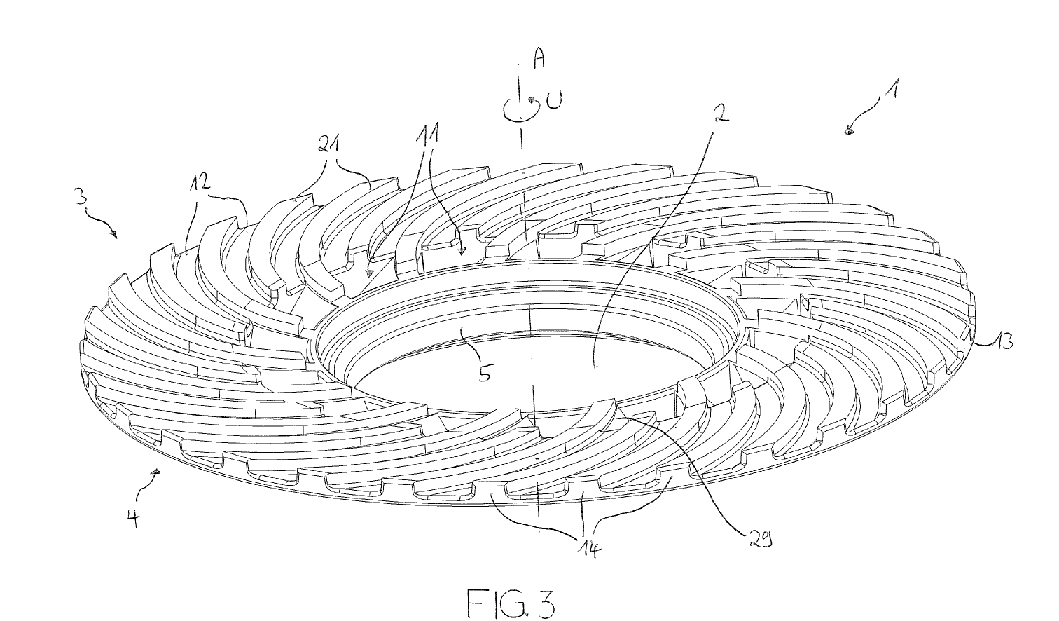

FIG. 2 shows a sectional illustration of a cooling disc according to the invention,

FIG. 3 shows a perspective view of a cooling disc according to the invention (obliquely from below),

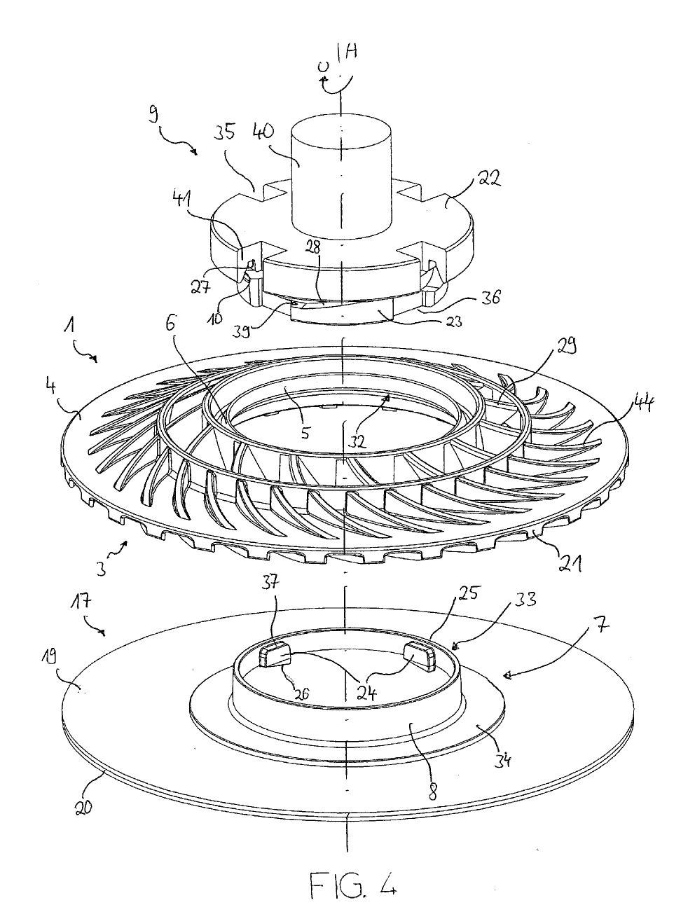

FIG. 4 shows a perspective illustration of a system comprising a cooling disc according to the invention, a fixture for a grinding tool and a grinding tool,

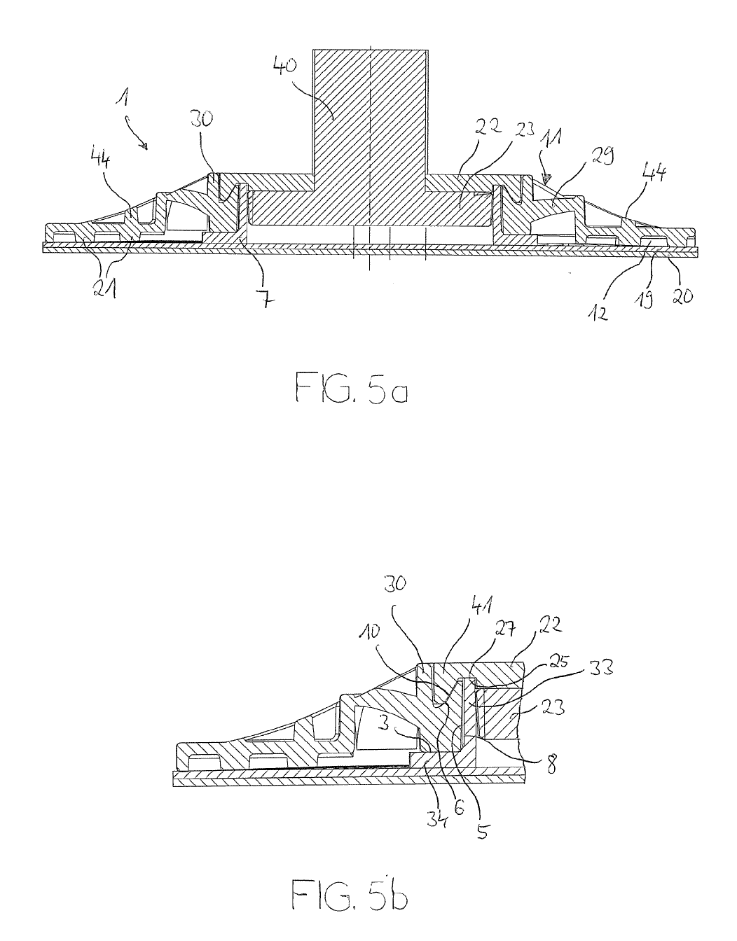

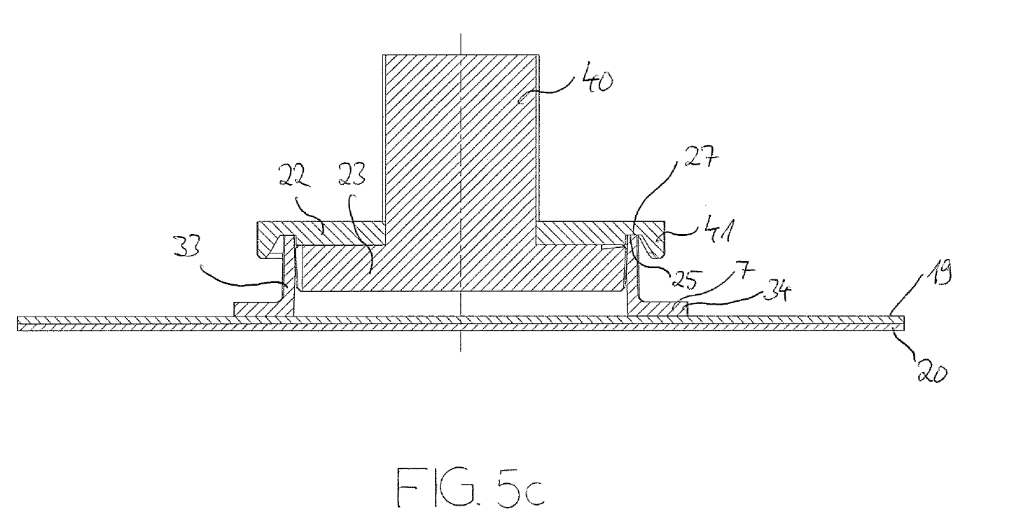

FIG. 5a shows a sectional illustration of a system comprising a cooling disc according to the invention, a fixture for a grinding tool and a grinding tool,

FIG. 5b shows an enlargement of a detail of the sectional illustration from FIG. 5a,

FIG. 5c shows a sectional illustration of a system comprising a fixture for a grinding tool and a grinding tool,

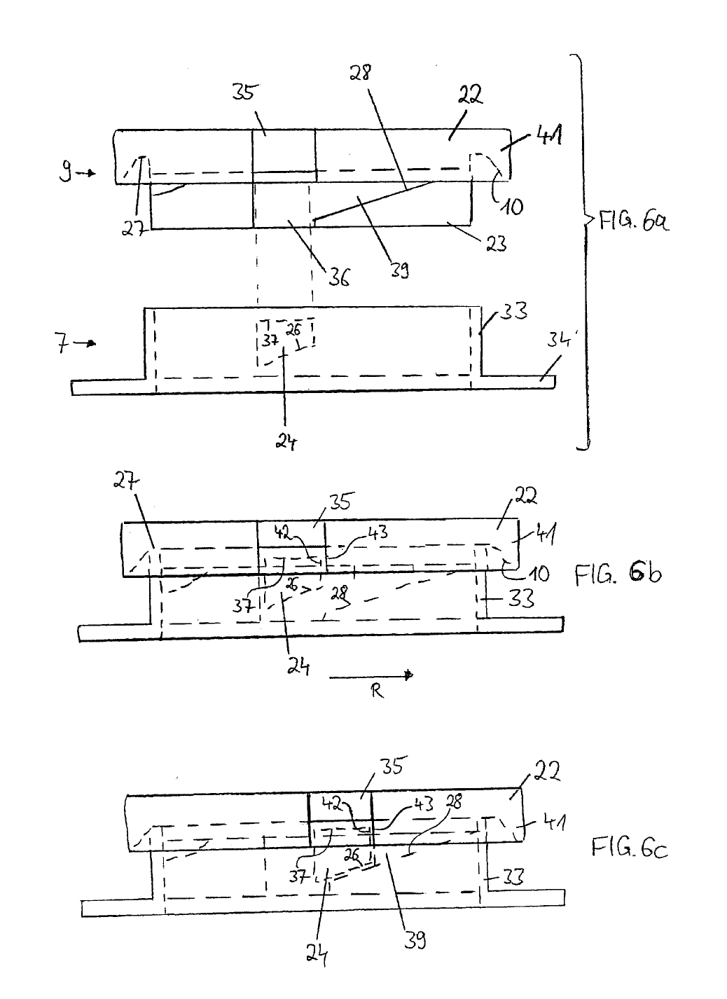

FIG. 6a shows an illustration of a detail of grooves and cams of a fixture and a holding element in a spaced-apart position,

FIG. 6b shows an illustration of a detail of grooves and cams of a fixture and a holding element in an inserted position, and

FIG. 6c shows an illustration of a detail of grooves and cams of a fixture and a holding element in a clamped position.

FIG. 1 shows a cooling disc 1 according to the invention in a perspective view. FIG. 2 shows a sectional illustration according to FIG. 1 through a plane which contains the rotational axis A. FIG. 3 shows a further perspective view.

The cooling disc 1 has a fastening opening 2 and a side 3 which can face a grinding tool and a side 4 which can face away from a grinding tool. The cooling disc 1 has substantially the shape of a circular disc, the side 4 which can face away from the grinding tool being configured in such a way that the cooling disc 1 is flatter at the outer circumference 13 than in the vicinity of the centre.

The cooling disc 1 has a plurality of ventilation openings 11 which penetrate it and extend from the side 4 which can face away from the grinding tool to the side 3 which can face the grinding tool. The ventilation openings 11 are wound around the rotational axis A in the form of left-handed helical lines and are delimited firstly by dividing faces 29 which have a shape which is similar to a turbine-wheel blade; secondly, the ventilation openings 11 are delimited by an inner cylindrical ring 30 and an outer cylindrical ring 31. On the side 4 which can face away from the grinding tool, outside the outer cylindrical ring 31, lamellae 44 which are connected to the latter are formed, which form spirals in plan view and serve to stabilize the cooling disc 1.

A collar 32 which delimits the fastening opening 2 is situated within the inner cylindrical ring 30. This collar 32 is connected to the inner cylindrical ring 30 on the side 3 which can face the grinding tool. The surface of the collar 32 is formed from a conical face which tapers conically in the direction of the side 4 which can face away from the grinding tool, which conical face forms the second contact face 6 and can be brought into contact with a corresponding face of a fixture 9 for a grinding tool (see below), and is also formed from a cylindrical face which forms a first contact face 5 and can be brought into contact with a corresponding face of a holding element 7 of a grinding tool (see below). The two contact faces converge to form a circular edge 16 on the side 4 which can face away from the grinding tool.

The side 3 which can face the grinding tool is penetrated by a plurality of channels 12 which comprise notches which extend parallel to the disc plane and in the form of a spiral. The channels 12 are separated from one another by a plurality of ridges 21. In the plan view of the side 3 which can face the grinding tool, the ridges 21 are arranged in such a way that, if they are passed through from the inside to the outside, they extend in the clockwise direction. The channels 12 open into openings 14 on the outer circumference 13 of the cooling disc 1. Each of the ventilation openings 11 opens into in each case two channels 12 on the side 3 which can face the grinding tool.

In this way, during rotation of the cooling disc 1 in the circumferential direction U, air can be guided through the ventilation openings 11 from the side 4 which can face away from the grinding tool to the side 3 which can face the grinding tool. This is improved by the adaptation of the circumferential direction U to the helical direction of the ventilation openings 11. On the side 3 which can face the grinding tool, the air can absorb the heat which is produced there and dissipate it to the surroundings at the openings 14 on the outer circumference 13. Here, the orientation of the spiral direction of the ridges 21 relative to the circumferential direction U and therefore relative to the helical direction of the ventilation openings 11 improves the outwardly directed guidance of the air on the side 3 which can face the grinding tool.

The cooling disc is preferably composed of plastic, particularly preferably of polypropylene or polyamide 6, and is produced in an injection-molding process.

In one exemplary embodiment, the cooling disc 1 has a diameter of approximately 110 mm. In the region of the inner cylinder ring 30, the thickness of the cooling disc 1 has an overall thickness of approximately 14 mm and, at the outer circumference 13, a thickness of approximately 3 mm.

The outer side of the inner cylinder ring 30 has a diameter of 62 mm, while the inner side of the outer cylinder ring 31 has a diameter of 78 mm. Approximately twelve to fifteen dividing faces 29 which wind around the rotational axis A over an angular range of approximately 18° are situated between these two cylinder rings 30, 31. This number of dividing faces 29 has proven to be a favorable compromise between the requirements of good suction firstly and good statics secondly.

The first contact face 5 which delimits the fastening opening 2 has a diameter of approximately 50 mm and a height of approximately 13 mm. The first contact face 5 and the second contact face 6 extend at an angle of approximately 30° with respect to one another.

The ridges 21 have a width of 2 mm and a thickness of approximately 1.5 mm in the axial direction. Each second ridge 21 extends partially on the end edge of a dividing face 29 and extends from a radius of approximately 35 mm as far as the outer circumference 13 of the cooling disc 1. The ridges 21 which lie between them extend from the radius of the inner side of the outer cylinder ring 31 as far as the outer circumference 13 of the cooling disc 1.

FIG. 4 shows an exploded illustration of the system according to the invention comprising a cooling disc 1, a fixture 9 for a grinding tool, and a grinding tool 17.

The grinding tool 17 is configured as a grinding disc and comprises substantially a carrying body 19 and an abrasive 20 (shown only schematically) which is arranged on the carrying body 19. Both the carrying body 19 and the grinding face 20 are of planar, circular and solid-surface configuration and, in particular, do not have any holes or notches. The carrying body 19 is composed at least partially of vulcanized fiber.

The shape and size of the cooling disc are adapted to the shape and size of the grinding disc. In particular, the cooling disc and the grinding disc have identical diameters.

A holding element 7 is attached on that side of the carrying body 19 which faces away from the grinding face 20, which holding element 7 comprises substantially a cylindrical ring 33, to which a flange 34 is fastened. Four cams 24 which are arranged uniformly over the circumference of the ring 33 at a spacing of 90° and protrude radially to the inside are provided on the inner side of the cylindrical ring 33. The upper side of the ring 33 forms a first contact face 25 which can be brought into contact with the first bearing face 27 of a first clamping disc 22 of the fixture 9. A second contact face 26 on the underside of the cam 24 extends at an angle to the first contact face 25 which is formed by the upper side of the ring 33.

Here, the cam 24 is of geometrically simple construction and, as viewed in radial plan view, has substantially a trapezoidal shape. Two side faces which extend in the axial direction A delimit the cam 24 laterally. In the axial direction A, the cam 24 is delimited firstly by a first stop face 37 which extends parallel to the upper side 25 of the ring 33 and secondly by a second stop face 26 which extends at an angle to the upper side 25 of the ring 33. Each of the stop faces 37 and 26 extends in a plane. Here, the second stop faces 26 are arranged obliquely in the direction of a right-handed helical line, with the result that they are oriented in the direction of a circumferential direction U when they are passed through in the direction of the carrying body 19.

On account of the inclined arrangement of the second contact face 26, the positioning of the carrying body in the fixture according to the invention is defined precisely: fastening with a flange 34 which is directed towards the grinding machine is not possible.

The holding element is preferably produced from plastic in an injection-molding process.

The fixture 9 comprises substantially a first clamping disc 22 and a second clamping disc 23 which can be rotated relative to one another. The second clamping disc 23 is connected to a drive shaft 40 which can be driven rotationally. For this purpose, the first clamping disc 22 has a central through hole which is not shown here. When the drive shaft 40 is at a standstill, the first clamping disc 22 can therefore be rotated relative to the drive shaft 40 and the second clamping disc 23.

A retaining collar 41 is situated on the outer circumference of the first clamping disc 22. A circumferential first bearing face 27 is situated within this retaining collar 41. The retaining collar 41 and the bearing face 27 are interrupted by a groove 35. The second clamping disc 23 is provided with a second bearing face 28. This bearing face 28 is arranged at an angle in relation to the first bearing face 27. An intermediate space 39 which is formed between the first bearing face 27 and the second bearing face 28 for receiving the cam 24 is accessible to the cam 24 as a result of a groove 36 on the circumference of the second clamping disc 23.

The first and second clamping discs 22, 23 are typically manufactured from a metallic material, such as aluminum.

During assembly of the constituent parts of the system according to FIG. 4, the grinding tool 17 is guided into the cooling disc 1 in a first step in such a way that that side of the carrying body 19 which faces away from the grinding face 20 comes into contact with that side 3 of the cooling disc 1 which can face the grinding tool and that cylindrical face of the ring 33 which is situated on the outer circumference and acts as corresponding face 8 on the holding element comes into a form-fitting contact with the first contact face 5 of the cooling disc 1. Here, the ridges 21 also come into contact with that side of the carrying body 19 which faces away from the grinding face 20, which serves for improved support of the grinding tool 17. Closed channels are formed in this way which are delimited on the one hand by the ridges 21 and on the other hand by the carrying body 19.

The external diameter of the flange 34 is selected in such a way that it terminates with the inner ends of those ridges 21 of the cooling disc 1 which extend partially on the end edge of the dividing face 29. Accordingly, it is approximately 70 mm in this example. The external diameter of the flange 34 is accordingly smaller than the internal diameter of the outer cylinder ring 31, with the result that the ventilation openings 11 are also connected to the channels 12 during contact of the cooling disc 1 with the carrying body 19 and the holding element 7.

In a second step, the fixture 9 for a grinding tool is placed onto the cooling disc 1 in such a way that the corresponding face 10 of the fixture 9 comes into contact with the second contact face 6 of the cooling disc 1 and the cams 24 of the holding element 7 pass through the grooves 35 of the first clamping disc 22 and the grooves 36 of the second clamping disc 23.

Finally, in a third step, the first clamping disc 22 is rotated with respect to the second clamping disc 23 in such a way that the cams 24 are clamped between the first bearing face 27 of the first clamping disc 22 and the second bearing face 28 of the second clamping disc 23. This mechanism will be described in greater detail further below.

FIG. 5a shows a sectional illustration of the system which is composed according to the above embodiments. FIG. 5b shows an enlarged detail from FIG. 5a which demonstrates the contact points between the individual components. The upper side of the first clamping disc 22 terminates flushly with the upper side of the inner cylindrical ring 30. The fixture 9 therefore enters with an accurate fit into the spatial region which is enclosed by the inner cylindrical ring 30. The upper side 25 of the ring 33 is in form-fitting contact with the bearing face 27 of the first clamping disc 22, which leads to the transmission of the axial forces. The outer, cylindrical circumference 8 of the ring 33 is in form-fitting contact with the first contact face 5 of the cooling disc 1. This makes transmission possible of radial forces between the holding element 7 and the cooling disc 1. Furthermore, that side 3 of the cooling disc 1 which can face the grinding tool is in form-fitting contact with the flange 34 of the holding element 7, which leads to axial force transmission between the cooling disc 1 and the holding element 7. Moreover, the retaining collar of the first clamping disc 22 engages into the cut-out between the inner cylinder ring 30 and the collar 32 in a form-fitting manner. In particular, the angle between the first contact face 5 and the second contact face 6 of the holding element 7 is adapted to the angle between the corresponding face 10 on the fixture 9 and the rotational axis A. As a result, radial forces are transmitted between the fixture 9 and the cooling disc 1 and therefore indirectly between the drive shaft 40 and the holding element 7. Finally, the contact between the ridges 21 which are not shown here in their full length on account of their spiral-shaped curvature and the carrying body 19 ensures support of the carrying body 19 on the cooling disc 1.

In combination with the function of the cam described in more detail below the entire cooling disc 1 is thus clamped between the fixture 9 and the grinding tool 17 in a form-fitting and force-transmitting manner.

As an alternative, it is possible to bring the fixture 9 directly into contact with the holding element 7 of the grinding tool 17, as is shown in the sectional illustration in FIG. 5c. In this case, the first bearing face 27 of the first clamping disc 22 also comes into contact with that circularly annular side of the ring 33 which faces away from the carrying body 19 of the grinding tool 17 on the holding element 7. Subsequently, the first clamping disc 22 is also rotated here with respect to the second clamping disc 23 in such a way that the cams 24 are clamped between the first bearing face 27 of the first clamping disc 22 and the second bearing face 28 of the second clamping disc 23. The ring 33 of the holding element 17 is also retained here on account of the protrusion of the corresponding face 10 in the radial direction, with the result that radial force transmission occurs between the holding element 7 and the fixture 9.

FIGS. 6a to 6c illustrate the above-described clamping of the cams 24 between the clamping discs 22, 23 using a side view, in which the cooling disc 1, the carrying body 19 and the drive shaft 40 are not shown. Only one cam 24 of the holding element 7 is shown diagrammatically in a dashed illustration.

FIG. 6a shows the fixture 9 and the holding element 7 in a position which is spaced apart in such a way that the cam 24 of the holding element 7 lies opposite the groove 35 of the first clamping disc 22 and the groove 36 in the second clamping disc 23.

In FIG. 6b, the fixture 9 and the holding element 7 are brought into contact with one another in such a way that the inner face of the ring 33 and the outer circumference of the second clamping disc 23 bear against one another in a form-fitting manner and, moreover, that annular face of the ring 33 which faces away from the flange 34 of the holding element 7 comes into contact with the first bearing face 27 of the first clamping disc 22. The cams 24 lie in the intermediate space 39 between the first clamping disc 22 and the second bearing face 28 of the second clamping disc 23. Furthermore, the cam 24 engages on an action face 43 of the first clamping disc 24 by way of a circumferential contact face 42.

If the second clamping disc 23 is held fixedly and a holding element 7 which has the cam 24 is rotated in the circumferential direction R, the first clamping disc 22 is rotated together with the cam 24 into the clamping position which is shown in FIG. 6c. In order that an engagement is possible between the circumferential contact face 42 and the action face 43, the cam 24 has to be of sufficiently long configuration in the axial direction A.

In FIG. 6c, that side of the cam 24 which faces the flange 34 has been brought into contact with the second bearing face 28 of the second clamping disc 23 by a relative rotational movement of the first clamping disc 22 and the second clamping disc 23 with respect to one another. In combination with the force which acts between the ring 33 and the first bearing face 27, a clamping action is therefore achieved which connects the holding element 7 to the fixture 9 releasably.

1. Cooling disc for cooling grinding tools, the cooling disc having
at least one fastening opening and
a side which can face a grinding tool and a side which can face away from the grinding tool,
characterized by
a first contact face which is configured in such a way that it can be brought into contact with a corresponding face of a holding element of a grinding tool, and
a second contact face which is configured in such a way that it can be brought into contact with a corresponding face of a fixture for a grinding tool.

2. Cooling disc according to claim 1, characterized by at least one ventilation opening which penetrates the cooling disc.

3. Cooling disc according to claims 1, characterized in that
the side which can face the grinding tool is provided with at least one channel which is designed for circulating the air in the space between the cooling disc and the grinding tool.

4. Cooling disc according to claim 3, characterized in that at least one of the channels opens into an opening on the outer circumference of the cooling disc.

5. Cooling disc according to claim 1, characterized in that at least one part of the first contact face is formed at least partially by a face which delimits one of the fastening openings.

6. Cooling disc according to claim 1, characterized in that the second contact face is directed to the outside.

7. Cooling disc according to claim 1, characterized in that one of the two contact faces is configured substantially as a cone envelope and the other contact face is configured substantially as a cylinder or cone envelope, in such a way that both contact faces converge to form an edge on that side which can face away from the grinding tool.

8. Cooling disc according to claim 7, characterized in that the first contact face is of cylindrical configuration and the second contact face is of conical configuration, the angle between the contact faces lying in the range between 20° and 45°.

9. Cooling disc according to claim 7, characterized in that the edge lies at a spacing from the side which can face the grinding tool, which spacing corresponds to only a fraction of the overall thickness of the cooling disc.

10. Grinding system, comprising
at least one grinding tool which is provided with a holding element,
a fixture for a grinding tool, and
at least one cooling disc,
characterized in that at least one of the grinding tools can be connected releasably by means of its holding element to the fixture in such a way that the cooling disc can be connected releasably to the fixture and the holding element.

11. Grinding system according to claim 10, characterized in that it comprises at least two cooling discs, at least two of the cooling discs being different from one another.

12. Grinding system according to claim 10, characterized in that at least one of the grinding tools can be connected releasably by means of its holding element directly to the fixture, without a cooling disc.

13. Grinding system according to claim 10, characterized in that the contact faces of at least one of the cooling discs are configured in such a way that
the first contact face is adapted to a corresponding face of a holding element of the grinding tool, and
the second contact face is adapted to a corresponding face of the fixture for a grinding tool,
with the result that the cooling disc can be clamped between the fixture and the holding element.

14. Grinding system according to claim 10, characterized in that the holding element of at least one grinding tool comprises a ring having a flange which extends radially to the outside, a plurality of cams, which are arranged uniformly over the circumference of the ring and which are extending radially to the inside from the inner side of the ring, at least one contact face of a cam coming into contact with a bearing face of the fixture during connection of the grinding tool by means of its holding element directly to the fixture and for connecting the grinding tool by means of its holding element to the fixture with simultaneous clamping of the cooling disc, and the outer side of the ring forming the corresponding face on the holding element.

15. Grinding tool having a carrying body and an abrasive which is fastened to the carrying body, the carrying body having at least one holding element, by means of which the carrying body can be fastened in a fixture for a grinding tool, characterized in that the grinding face is substantially planar and closed and the carrying body comprises vulcanized fiber.

16. Grinding tool having a carrying body, characterized in that the carrying body comprises vulcanized fiber and has a thickness of at most 0.4 mm.

17. Grinding system according to claim 10, characterized in that at least one of the grinding tools has a carrying body and an abrasive which is fastened to the carrying body, the carrying body having at least one holding element, by means of which the carrying body can be fastened in a fixture for a grinding tool, wherein the grinding face is substantially planar and closed and the carrying body comprises vulcanized fiber.

18. Grinding system according to claim 10, characterized in that at least one of the grinding tools has a carrying body, wherein the carrying body comprises vulcanized fiber and has a thickness of at most 0.4 mm.
